(19) United States
(12) Patent Application Publication
(10) Pub. No.: US 2011/0290278 A1
(43) Pub. Date: Dec. 1, 2011

(54) Fuse prong and receptacle cleaning tools

(76) Inventor: Rinaldo Swayne, Carson, CA (US)

(21) Appl. No.: 12/802,128

(22) Filed: Jun. 1, 2010

(51) Int. Cl. B08B 7/00; B08B 1/00

(52) U.S. Cl. 134/6; 15/104.001

(57) ABSTRACT

Tools for cleaning the blades of ATO and ATM type fuses and the fuse holding female receptacle in the fuse box. The fuse blade cleaning tool has two fuse female receptacles sized to receive the blades on the ATM and ATO type fuses. The receptacle cleaning tool has two sets of male blades having rough surfaces and sized to have access to various fuse panels to clean the interior surfaces of the female receptacle in the fuse box.

### BACKGROUND OF THE INVENTION

1. Field of the Invention

The present invention provides a tool for cleaning the blade terminals on ATO and ATM fuses and a tool for cleaning the female ATO and ATM receptacles.

2. Description of the Prior Art

Plug-in type fuses are typically utilized in fuseboxes found in automobiles, motorcycles, audio equipment and other electrical circuits and come in four physical sizes, including the ATO fuse (19.1×5.1×18.5 mm) and ATM fuse (10.9×3.6×16.3 mm).

Frequently, especially in an automobile or motorcycle the fuse contacts become dirty or oxidized over time. It is common to attempt to clean the fuse receptacle by spraying a liquid, e.g., WD-40 into the receptacle. Spray chemicals usually do not provide a thorough cleaning and are messy. Due to space restraints in the fusebox it is even more difficult to clean the receptacles using sandpaper or emery cloth. Those methods usually end up in small pieces of paper, which has become torn up while inserting them into the receptacle, causing even more intermittent circuit connections.

What is thus desired is to provide tools that clean the fuse blade and the fuse receptacle contacts in a more effective and efficient manner when compared to the above-noted prior art techniques.

### SUMMARY OF THE INVENTION

The present invention provides two small tools that allow for a more thorough cleaning of both the male blade terminals on a fuse and the female receptacle where the fuse is inserted in the fusebox. Due to the tools having a built-in rough surface, similar to an etched surface on a fingernail file, the tools effectively remove oxidation and dirt buildup on the fuse and fuse receptacle contacts. The fuse contact cleaning tool has two sets of fuse female receptacles which are the same size as those found on ATM and ATO type fuses. The receptacle cleaning tool has two sets of male blades which are also the same size as the fuse blades found on ATM and ATO fuses. The length of the blades are slightly longer than the fuse contacts to allow easier access into various fuse panels.

### DESCRIPTION OF THE DRAWINGS

For a better understanding of the present invention as well as other objects and further features thereof, reference is made to the following description which is to be read in conjunction with the accompanying drawing therein:

FIG. 1A is a plan view of a prior art mini (ATM) type fuse and FIG. 1B is a side view thereof;

FIG. 2A is a plan view of a prior art regular (ATO) fuse and FIG. 2B is a side view thereof;

FIG. 3 illustrates a fuse blade cleaner in accordance with the teachings of the present invention; and

FIG. 4 illustrates a fuse receptacle cleaning tool in accordance with the teachings of the present invention.

### DESCRIPTION OF THE INVENTION

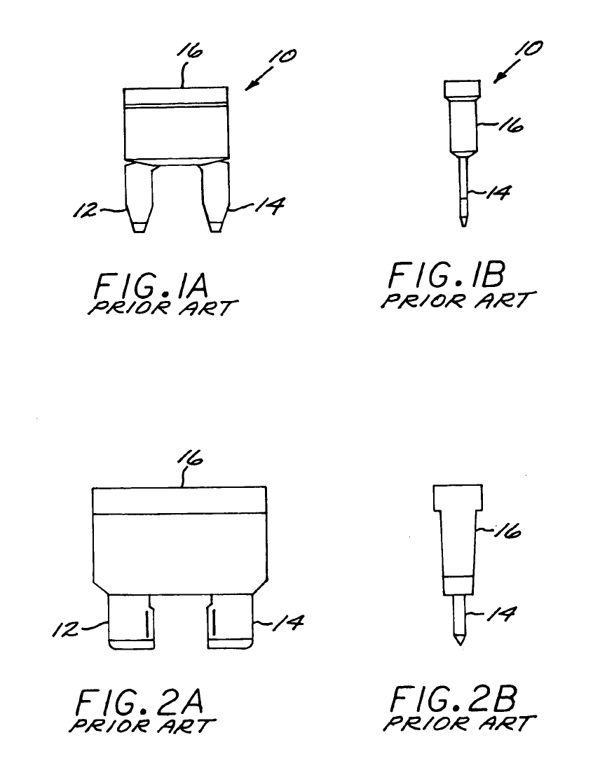

FIG. 1 illustrates a prior art mini (ATM) plug-in type fuse 10 having prongs 12 and 14. Plug-in fuses (also known as blade or spade fuses) typically comprise plastic body (16) and prongs (12 and 14) that fit into sockets and are mostly used in vehicles. The fuses protect the vehicle wiring and electrical equipment.

These fuses come in four different physical dimensions, the mini shown in FIGS. 1A and 1B and regular (the ATO fuse 20 shown in FIGS. 2A and 2B). Blade type fuses can be mounted in fuse blocks, in-line fuse holders or fuse chips. The ATM fuse receptacle is smaller than the ATO fuse receptacle.

Referring to FIG. 3, a perspective view of the fuse blade cleaner 30 of the present invention is illustrated. Cleaner 30 comprises member 32 having blade cleaner insert 38 formed therein, the insert containing a pair of metal receptacles 40 and 41 having etched internal surfaces for the ATO fuse; cleaner insert 42 has receptacles 44 and 45 having etched rough surfaces for an ATM fuse.

Block member 30 is typically fabricated from molded plastic and is approximately 2 inches wide, 2 inches in height and 1.5 inches in width. The internal surfaces of each receptacle 40, 41, 44 and 46 are formed by metal milling before being rolled or shaped. The complete assembly is then inserted or molded into the plastic housing 32. The dimensions of the inserts and the receptacles correspond to the size of the terminals on the ATM and ATO fuses. Note that various techniques can be utilized to form the internal surfaces of each receptacle and the inserts 38 and 42.

In operation, a user first removes a fuse from the fuse box and then inserts the prongs thereof into either the ATO or ATM cleaner receptacle. The fuse is then moved up and down a number of times in the vertical direction which removes dirt and oxidation from the prongs. The fuse is then removed from the cleaner and then either stored or re-inserted into the fuse box.

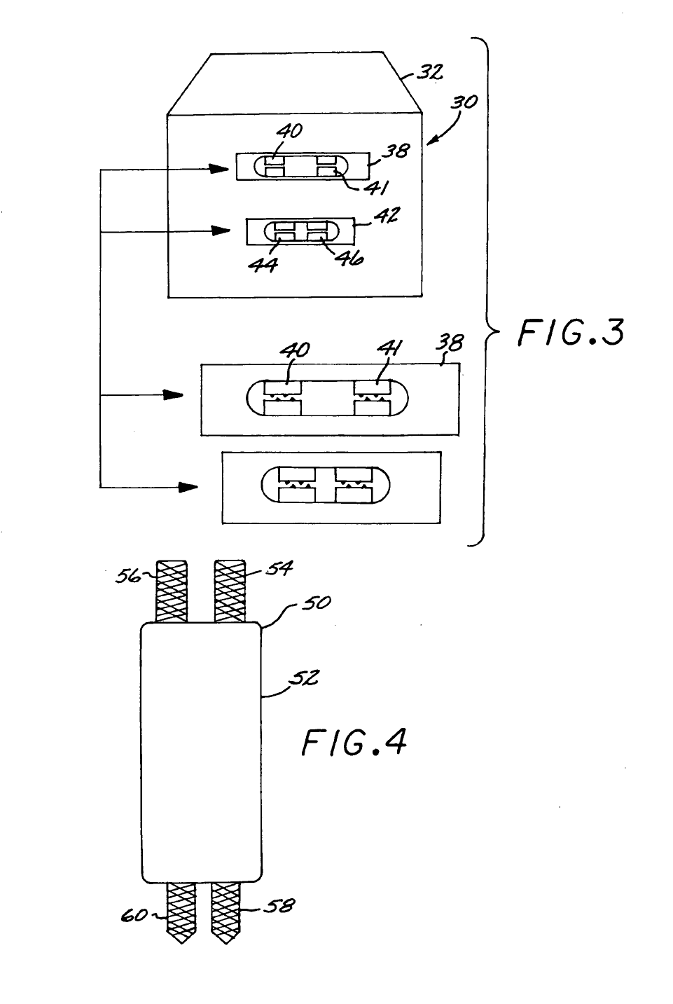

FIG. 4 illustrates a fuse receptacle cleaning tool 50 which comprises molded plastic member 52 and blades 54 and 56 with both surfaces being etched for ATO type fuses and blades 58 and 60 with both surfaces etched for cleaning ATM type fuses.

The blades are made of metal and are machine milled on both surfaces of the blades before being encased in molded plastic housing 52.

In operation, the fuses in the vehicle fuse box are first removed and either blades 54 and 56 or 58 and 60 are inserted in the appropriate fuse box receptacle. The user then grasps body 52 and the cleaning tool 50 moved up and down a number of times in the vertical direction. The cleaning tool 50 is then removed from the fuse box and the appropriate fuses re-inserted into the fuse box.

The present invention thus provides a simple and cost effective tools for cleaning the prongs of a fuse and the fuse box in which the fuses are operatively positioned.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A tool for cleaning a first set of blades on a first type of plug-in fuse comprising a block shaped member having a first insert formed therein, a first receptacle being formed within said first insert, an inside surface of said first receptacle being etched and sized to receive said blades.

2. The tool of claim 1 further including a second insert formed therein, a second receptacle being formed within said second insert, wherein said tool has the capability of cleaning a second set of blades on a second type of plug-in fuse.

3. The tool of claim 2 wherein the shape of said first set of blades is different than the shape of said second set of blades.

4. A tool for cleaning fuse box receptacles comprising a member having first and second ends, first and second blades extending from said first member end, third and fourth blades extending from said second member end, said first and second blades having a shape different from said third and fourth blades.

5. The tool of claim 4 wherein at least one surface of said first, second, third and fourth blades is etched.

6. A method of cleaning a first set of blades on a first type of plug-in fuse comprising the steps of:
providing a block shaped member having a vertical axis and having a first insert formed therein, a first receptacle being formed within said first insert; at least one surface of said first receptacle being roughened;
inserting said first set of blades within said first receptacle; and
moving said plug-in fuse in a vertical direction a plurality of times wherein the surfaces of said first set of blades are cleaned.

7. A method of cleaning fuse box receptacles comprising the steps of:
providing a member having first and second ends and a vertical axis, first and second blades extending from said first member end, at least one surface of said first and second blades being roughened;
inserting said first and second blades within said fuse box receptacles; and
moving said member in a direction along said vertical axis a plurality of times wherein said receptacles are cleaned.
